(19) United States
(12) Patent Application Publication
(10) Pub. No.: US 2007/0240140 A1
(43) Pub. Date: Oct. 11, 2007

(54) Methods and systems for application load distribution

(75) Inventors: Louis Ralph Degenaro, White Plains, NY (US); Lei Gao, Foster City, CA (US); Arun Kwangil Iyengar, Yorktown Heights, NY (US); Isabelle Marie Rouvellou, New York, NY (US); Jian Yin, Bronx, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 11/351,831

(22) Filed: Feb. 10, 2006

(51) Int. Cl. G06F 9/45

(52) U.S. Cl. 717/158

(57) ABSTRACT

Improved application load distribution techniques are disclosed. For example, a technique for distributing a load associated with an application among multiple computing devices comprises analyzing, at a time other than runtime, code associated with the application to determine how to approximately partition the code and how to approximately partition data associated with the application to minimize a cost of interaction between partitions. Further, the technique may comprise analyzing, at runtime, the load associated with the application and partition interactions to refine one or more partition definitions. Still further, the technique may comprise adjusting, at runtime, a placement of partitions based on at least one of the analysis at a time other than runtime and the analysis at runtime.

### FIELD OF THE INVENTION

The present invention generally relates to information systems and, more particularly, to techniques for distributing a load associated with an application in an information system.

### BACKGROUND OF THE INVENTION

In general, an information system is a data processing system that provides some form of response to a user upon a user's request. The Internet or World Wide Web (WWW or the “web”) is easily the most ubiquitous information system that exists today.

In the web environment, it is known that many large-scale electronic commerce (e-commerce) services must handle high rates of requests, and request rates for those services are typically increasing over the course of years. A cluster of machines is usually the hardware platform for providing the processing power needed by those. high-throughput applications because of low cost and incremental scalability. By low cost here, it is meant that a cluster of machines (e.g., multiple distributed servers) is usually more cost-effective than one large centralized server, for providing the same amount of processing powers. By incremental scalability here, it is meant that the processing power of a cluster can be increased simply by adding more machines.

With the advent of grid computing technology, additional hardware capacity could be provisioned to a service instantly from a computing utility grid, as demand for capacity increases. Thus, with incremental scalability, even a quality of service (QoS) conscious service provider can provision hardware capacity based on current load instead of the theoretical highest load, which leads to better utilization of hardware resources.

It is known that the Java 2 Platform, Enterprise Edition (J2EE) from Sun Microsystems, Inc. (Santa Clara, Calif.) is becoming increasingly popular for writing portable and reusable software for large-scale e-commerce services. One of the reasons is that the J2EE standard is becoming widely accepted. J2EE is a component-based programming model that allows programmers to focus on specifying business logic by relegating concurrency control, availability, and security support to the underlying runtime system. By allowing programmers to focus only on programming logic, the J2EE programmer model allows robust, secure mission-critical enterprise applications to be developed at a low cost and a short development cycle, which is important for many e-commerce businesses in highly competitive market environments.

Cluster support of J2EE applications is part of the responsibility of the J2EE runtime system. Effective cluster support for distributing the load of a J2EE application over a cluster of machines is critical for scalability and efficiency of the J2EE application over a cluster. By scalability here, it is meant that the highest throughput can be sustained by a J2EE application over a cluster. Synchronization bottlenecks can limit the throughput that can be achieved by a cluster of machines. Thus, removing synchronization bottlenecks is essential for cluster support of J2EE applications. By efficiency here, it is meant how efficiently hardware in a cluster is utilized.

The problem of partitioning an application into a set of loosely coupled machines has been studied in the parallel computing community. Examples include “Global Optimizations for Parallelism and Locality on Scalable Parallel Machines,” Proceedings of ACM SIGPLAN PLDI′1993, pp. 112-125, Albuquerque, N.Mex., 1993. However, partitioning in parallel computing is different from the e-commerce service problem in that partitioning in parallel computing is usually just involved in partitioning the computation of one large batch request. Partitioning in such a case is used to increase parallelism of the computation of one batch request to accelerate the task completion. In the e-commerce service setting, the load of an e-commerce application is incurred by many real-time requests.

Accordingly, a need exists for techniques which overcome the above-mentioned and other limitations associated with existing application load distribution.

### SUMMARY OF THE INVENTION

Principles of the invention provide improved application load distribution techniques.

For example, in one aspect of the invention, a technique for distributing a load associated with an application among multiple computing devices comprises analyzing, at a time other than runtime, code associated with the application to determine how to approximately partition the code and how to approximately partition data associated with the application to minimize a cost of interaction between partitions.

Further, the technique may comprise analyzing, at runtime, the load associated with the application and partition interactions to refine one or more partition definitions. Still further, the technique may comprise adjusting, at runtime, a placement of partitions based on at least one of the analysis at a time other than runtime and the analysis at runtime.

The analysis step, at a time other than runtime, may further comprise interacting with an application developer to obtain information relating to one or more execution patterns or one or more request patterns.

The adjustment step, at runtime, may further be based on a capacity associated with each of the plurality of computing devices. The adjustment step, at runtime, may further be based on a request pattern of the application.

An interaction between two partitions may comprise at least one of: (i) an interaction resulting from a remote method invocation from one of the two partitions to the other of the two partitions; (ii) a consistency maintenance based interaction resulting from data being replicated in one of the two partitions from the other of the two partitions; (iii) a remote data access based interaction resulting when requested data is not locally available in one of the two partitions and has to be accessed from the other of the two partitions; and (iv) an interaction resulting from reloading of remote data from one of the two partitions locally in the other of the two partitions when a cache copy of local data is not available.

A cost of interaction between partitions may comprise at least one of: (i) a cost incurred by an increase in a user response time; (ii) a cost incurred by a processing overhead; (iii) a cost incurred by a network bandwidth consumption when a request has to be processed in stages by two or more of the plurality of computing devices; (iv) a cost incurred by a request causing consistency maintenance; and (v) a cost incurred by a request causing a remote data fetch.

A capacity associated with each of the plurality of computing devices may comprise at least one of: (i) one or more attributes associated with a processor of the computing device; (ii) one or more attributes associated with random access memory of the computing device; (iii) one or more attributes of a network to which the computing device connects; (iv) one or more attributes of a disk of the computing device; and (v) one or more attributes associated with software of the computing device.

A request pattern may comprise at least one of: (i) a total number of requests; (ii) a number of requests for each partition; (iii) a cost of each request in terms of at least one of a processing time, a memory consumption, and disk and network overhead.

The analysis step, at a time other than runtime, further comprises one or more of: constructing a code graph to capture a code execution flow; annotating code with underlying data that requires consistency; generating a code partition that minimizes overhead and latency by reducing interactions among partitions; partitioning the load further by partitioning underlying data and aligning partitioned data; and generating a request-to-partition association.

The code graph may be constructed at one of a plurality of granularity levels, wherein the plurality of levels comprises a basic block level, a procedure level, and a component level.

The analysis step, at a time other than runtime, may further comprise using a model of J2EE semantics to determine if a piece of data requires consistency.

The step of annotating the code may further comprise annotating the code with one or more characteristics of the data, wherein a characteristic comprises at least one of: (i) an indication that the data is read only data; (ii) an indication that the data is read and write data; and (iii) an indication of a relative read or write frequency as compared to other partitions.

The analysis step, at a time other than runtime, may input at least one of: (i) code associated with the application; (ii) configuration information associated with the application; (iii) one or more partition aggressiveness requirements; (iv) one or more anticipated code execution patterns; (v) one or more anticipated data access patterns; and (vi) one or more anticipated request patterns.

The one or more partition aggressiveness requirements may comprise at least one of: (i) a required number of computing devices to achieve a given throughput; (ii) a desired number of partitions; (iii) upper limits on the amount of interaction between partitions; and (iv) upper limits on the latency for each type of request resulting from control transfers between different code partitions to process the requests.

The analysis step, at a time other than runtime, may account for a tradeoff between efficiency and scalability by changing the number of partitions generated.

The application may be a J2EE application and the analysis step, at a time other than runtime, may further comprise performing a data flow analysis to align data in the J2EE application by exploiting semantics of one or more container-managed relations.

Code describing a request-to-partition association may be extracted via a forward code slicing operation.

The analysis step, at runtime, may further comprise one or more of: gathering partition interaction statistics; gathering partition load statistics; and refining one or more partitions based on at least one of the partition interaction statistics and the partition load statistics.

Partition interaction statistics may further comprise at least one of: (i) statistics relating to a consistency sharing conflict of underlying data of existing or potential future partitions; and (ii) statistics relating to a remote procedure call or a remote method invocation from one to another existing or potential future partition.

Partition refinement may further comprise at least one of: (i) merging of partitions; (ii) splitting of a partition; and (iii) moving a part of a processing operation from one partition to another partition. Partition refinement may further comprise splitting one partition based on a runtime observation that one or more code paths are rarely traversed in a code graph. Partition refinement may be formulated and solved as a graph-cut problem.

Partition placement adjustment, at runtime, may further comprise: inputting a measure of a processing capacity associated with each computing device; gathering current load information for each partition; and generating a new partition placement based on at least one of the processing capacity of each of the computing devices and the current load information for each partition.

The current load information of each partition may further comprise at least one of: (i) a processor overhead incurred for the partition during a given period of time; and (ii) a memory requirement of the partition during a given period of time.

Partition placement adjustment, at runtime, may further comprise placing routing processing operations at one or more backend nodes where requests are processed.

In a second aspect of the invention, a technique for distributing a load associated with an application among a plurality of computing devices comprises analyzing a runtime request pattern to generate one or more new partition definitions or refine one or more previously-generated partition definitions.

In a third aspect of the invention, a technique for load balancing partitions at runtime comprises adjusting, at runtime, a placement of partitions based on a load of at least one partition.

The technique may further comprise collecting statistics at runtime, wherein statistics include an actual cost of partition interactions among partitions such as remote method invocations or data share conflicts. Runtime partition placement may be formulated as a graph-cut problem. The technique may further comprise evaluating two or more plans of partition placement adjustment so as to minimize one or more of processing overhead and service unavailability during the partition placement adjustment.

Furthermore, such above-mentioned techniques may be implemented in accordance with apparatus comprising a memory and at least one processor coupled to the memory and operative to perform the above-mentioned operations, and as an article of manufacture comprising a machine readable medium containing one or more programs which when executed implement the above-mentioned steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a system architecture, according to an embodiment of the present invention;

FIG. 2 is a diagram illustrating a static analysis engine, according to an embodiment of the present invention;

FIG. 3 is a diagram illustrating a method for distributing application load, according to an embodiment of the present invention;

FIG. 4 is a diagram illustrating a code graph, according to an embodiment of the present invention;

FIG. 5 is a diagram illustrating a transformed code graph, according to an embodiment of the present invention;

FIG. 6 is a diagram illustrating a dynamic analysis engine, according to an embodiment of the present invention;

FIG. 7 is a diagram illustrating a placement manager, according to an embodiment of the present invention; and

FIG. 8 is a diagram illustrating a computing system in accordance with which one or more components/steps of an application load distribution system may be implemented, according to an embodiment of the present invention.

### DETAILED DESCRIPTION OF PREFERRED EMBODIMENTS

Principles of the present invention will be explained below in the context of an illustrative Internet or web-based client-server environment. However, it is to be understood that the present invention is not limited to such Internet or web implementations. Rather, the invention is more generally applicable to any request-based environment in which it would be desirable to provide improved application load distribution performance.

Furthermore, content that is to be served in response to a request may be referred to generally herein as an “object.” An “object” may take on many forms and it is to be understood that the invention is not limited to any particular form. For example, an object may be an electronic document such as one or more web pages. One skilled in the art could use the invention in a variety of different electronic document formats including, but not limited to, HTML (Hyper Text Markup Language) documents, XML (Extensible Markup Language) documents, text documents in other formats, and binary documents. Also, the phrase “electronic document” may also be understood to comprise one or more of text data, binary data, one or more byte streams, etc. Thus, the invention is not limited to any particular type of data object.

Still further, it is to be understood that the term “application” generally refers to any machine-readable code that performs a function. By way of example, an application may include, but is not limited to, one or more programs that enable the provision and operation of one or more e-commerce services. Also, the term “machine” generally refers to a computing device, by way of example, a server. Thus, by way of further example, a cluster of machines may comprise two or more servers. These servers may be remotely located or collocated. The invention is not limited to any particular cluster configuration.

Principles of the invention realize that there can be different approaches to distribute application load. One way to partition the application is by the functional units contained in an application. As used herein, a functional unit may be considered a software module that implements a relatively independent task in a certain granulation level. For example, in a three-tiered J2EE platform, the web server, the Java application server, and the database can be considered as functional units. In a finer granulation, each Java class or function can also be considered as a functional unit. Such an approach distributes these functional units. The advantage of this approach is that it is relatively simple. However, for many large-scale applications, this approach may be insufficient in terms of scalability and performance.

First, the number of functional units is limited. Thus, one can only distribute an application into a limited number of machines, if one does not replicate the functional units. For applications that require strong consistency, replication may not increase the overall system capacity because of synchronization cost. Synchronization is the process of keeping each replicated functional unit updated. Thus, the scalability offered by functional unit partition may be limited.

Second, after an application is partitioned based on functional units, a request may need to be processed by several functional units before the response can be produced. If these functional units are distributed over several machines, user response time may be increased because of message delays between machines. Thus, when one partitions an application by functional units, it is advantageous to place the functional units that process the same requests into the same functional partitions to reduce user response time.

Another approach is to partition the underlying data associated with requests. This approach takes a data-centric point of view in which system performance is optimized statically and dynamically based on how data are manipulated during the time when a J2EE application processes requests. Even though several requests are processed by the same piece of code, they could manipulate different pieces of underlying data. Thus, principles of the invention realize that it is possible to further partition the functional unit based on the underlying data. If one can partition underlying data to reduce interactions between partitions, one can increase the number of partitions without risking the bottleneck and overhead of synchronization. More high-quality partitions offer opportunities to better utilize more machines.

Accordingly, an illustrative embodiment of the invention provides the following system architecture. Given a J2EE application, the system performs a static analysis to determine how the application can be partitioned. These partitions are called “atomic partitions.” An atomic partition is a small partition which requires minimal synchronization, which can be identified before the system is running. More particularly, an atomic partition is considered a minimal partition subjected to certain synchronization requirements between partitions. For example, if the synchronization requirement is that no data in different partitions should need synchronization and two pieces of data, A and B, are always accessed by different requests, then A and B should be placed into different partitions. The reason here is that a partition including both A and B is larger than a partition including only one of them.

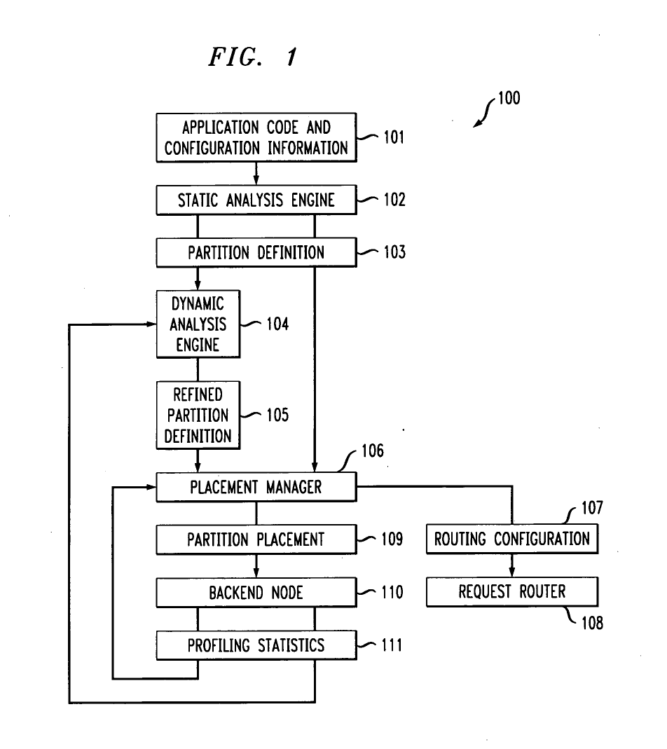

In an illustrative system, atomic partitions are defined with a classifying function. This classifying function inputs a request and outputs a partition name. The classifying function may be a part of a request router (e.g., request router 108 of FIG. 1 to be described below). When a request comes into a request router, the request is classified into a partition and then is routed to the backend node (e.g., backend node 110 of FIG. 1 to be described below) where the partition is hosted. This approach obviates the requirement to enumerate the requests, which may be too numerous.

Also, this approach allows a partition to be added at runtime dynamically. “Runtime” is the time when the application is actually running and is processing requests. The “runtime system” is the part of the system that supports the application during runtime. Examples include the memory management system. A specific example here is the request router.

It is to be appreciated that “static analysis” (or “statically analyzing”) means analysis before or after runtime (i.e., not at nor during runtime), while “dynamic analysis” (or “dynamically analyzing”) means analysis at or during runtime. For some applications, static analysis is sufficient. For other applications, it is difficult to align the data before runtime, thus runtime profiling and dynamic alignment may be required. Partitioning also introduces another complication. Since requests can be processed only by the machines that host the corresponding partition, the system may need to be load-balanced at a partition-level rather than at a request-level.

Thus, principles of the invention provide techniques for partitioning the load of an application through both static analysis and dynamic analysis. They also provide for partition placement at runtime for load balancing and QoS purposes. Thus, partition placement and adjustment of partition placements is considered “dynamic” when done during runtime. However, it is to be understood that advantages over existing approaches are realized when only static analysis, dynamic analysis or dynamic adjustment is individually performed.

Referring initially to FIG. 1, a system architecture according to an embodiment of the invention is depicted. As shown, system 100 comprises static analysis engine 102, dynamic analysis engine 104, placement manager 106, one or more request routers 108, and one or more backend nodes 110.

Again, it is to be understood that “static analysis” with respect to engine 102 means the program analysis performed during the time before or after the application is running. Such a time other than runtime may be compile time. “Dynamic analysis” with respect to engine 104 means the analysis performed during application running time, when the requests are processed (i.e., runtime).

Static analysis engine 102 inputs application code and configuration information 101 and generates a complete or incomplete partition definition 103. A partition definition describes how an application can be partitioned. As shown, partition definition 103 is passed to dynamic analysis engine 104 for further refinement so as to generate refined partition definition 105 (to be further described below). The partition definition (and refined partition placement, if so generated) is also passed to placement manager 106. The placement manager decides how to place partitions (partition placement 109) onto backend nodes 110 based on runtime partition load statistics (profiling statistics 111) incurred by each partition. Request routers 108 route requests to the partition that requests belong to based on request-to-partition association that is generated by static analysis engine 102 or dynamic analysis engine 104. The routers are configured based on routing configuration information 107 received from placement manager 106. Routers can be separated or physically located on backend nodes that also process requests. Backend nodes are located in a cluster of machines.

The functionality performed by static analysis engine 102 is to use static analysis to partition the load of e-commerce applications. We use J2EE applications as our example.

J2EE follows the client/server paradigm where clients are only usually “thin” (minimal processing functions) and are thus typically only responsible for forwarding users' requests to servers, and processing and displaying the responses received back from servers. The servers are “thick” in terms of processing and are thus responsible for processing users' requests and sending replies back to clients. Most of the service states are also hosted in servers. A server usually services the requests from many clients, and thus a server usually requires high computing and storage capacity. It is usually important to make servers scalable. These requests are usually Hyper Text Transfer Protocol (HTTP) requests sent over the Internet from client machines to server machines.

J2EE uses a component-based model to construct applications. A J2EE application comprises many portable components, e.g., Servlets, Java Server Pages (JSPs), and Enterprise Java Beans (EJBs) which can be deployed with XML files to J2EE application servers that host these components.

A J2EE application server is also referred to as “J2EE containers” since the application server hosts J2EE components. A J2EE application server is conceptually similar to an operating system which manages both computing resources and the J2EE components running on it. According to deployment XMLs, J2EE application servers initiate components and manage the instances of these components. J2EE containers also provide many high-level system services, which usually are not provided by traditional operating systems.

Static analysis engine 102 not only understands the semantics of the Java language, but also models the J2EE specification. As shown in FIG. 2, input to the static analysis engine (collectively denoted as 101, as in FIG. 1) can include business logic 202, data source configuration 203, and deployment descriptors 204. Business logic is the Java code which specifies how a request is to be processed. Business logic can include Servlets, JSPs, and EJBs. Data source configuration can include which database sources are mapped to which database. The input to the static analysis engine can also include such information as expected request rates and patterns, expected code execution patterns, expected data access patterns, number of partitions desired, and number of machines hosting the partitions. This information (referred to in FIG. 2 as partition aggressiveness 205) can help the analysis engine to determine how aggressively to partition an application since, in some case, the analysis engine may need to trade off efficiency of partitioning for aggressiveness of partitioning. By aggressiveness of partitioning here, it is meant how many partitions to be produced. For example, if it is known that an application will sustain high throughput and must leverage a large number of machines for that purpose, the system can opt to produce a large number of partitions even though there could be considerable interactions among these partitions. On the other hand, if a smaller number of partitions are needed due to a lower request rate, the system could produce partitions with less interaction among these partitions.

Furthermore, static analysis engine 102 can analyze the code interactive with application program developers 207 by posing questions to application developers on code execution patterns or request patterns from application developers. However, it is to be appreciated that the static analysis engine can analyze the code without interactions with application program developers.

The output of static analysis engine 102 can be a complete partition definition or an incomplete partition definition (referred to as 103 in FIG. 2). A complete partition definition can be passed to the runtime system 206 for a dynamic partition placement. It is to be understood that the runtime system 206 in FIG. 2 may include the placement manager, backend nodes and request routers shown in FIG. 1. For some applications, static analysis does not have enough information on data and code access patterns and thus can not produce efficient partitions. For example, the system can know that there is not enough information when dynamic analysis with runtime information results in better partitioning than that by static analysis without runtime information. In these cases, the static analysis engine can either produce an incomplete partition definition or a complete partition definition. Both complete and incomplete partition definition can be refined at runtime based on runtime statistics concerning code and data interactions.

Thus, it is to be understood that dynamic analysis can affect complete and incomplete partition definitions by refining these partition definitions. For example, static analysis at compile time may determine that two pieces of data, A and B, could be accessed together, thus a decision could be made to place both A and B into a partition P1. But dynamic analysis may find that the two pieces of data are not accessed together and, thus, partition P1 could be split into two partitions, one including A, and another including B.

Program analysis at compile time can be imprecise due to computation complexity and lack of running time information. For example, static analysis may decide that two pieces of data, A and B, can be accessed at the same time in a piece of code. But it is possible that A and B are never accessed together because, at runtime, there does not exist the type of requests that cause the two variables to be accessed at the same time.

An application can be partitioned by partitioning the code or partitioning the data. The definition of a partition can include both one or more code elements and one or more data elements. The partition definition can also include application characteristics that can help runtime partition refinement and partition placement. The code element (which may be considered as synonymous with the phrase “functional unit” used above) is the piece of code that a partition executes. The data element is the piece of data that the requests in this partition access.

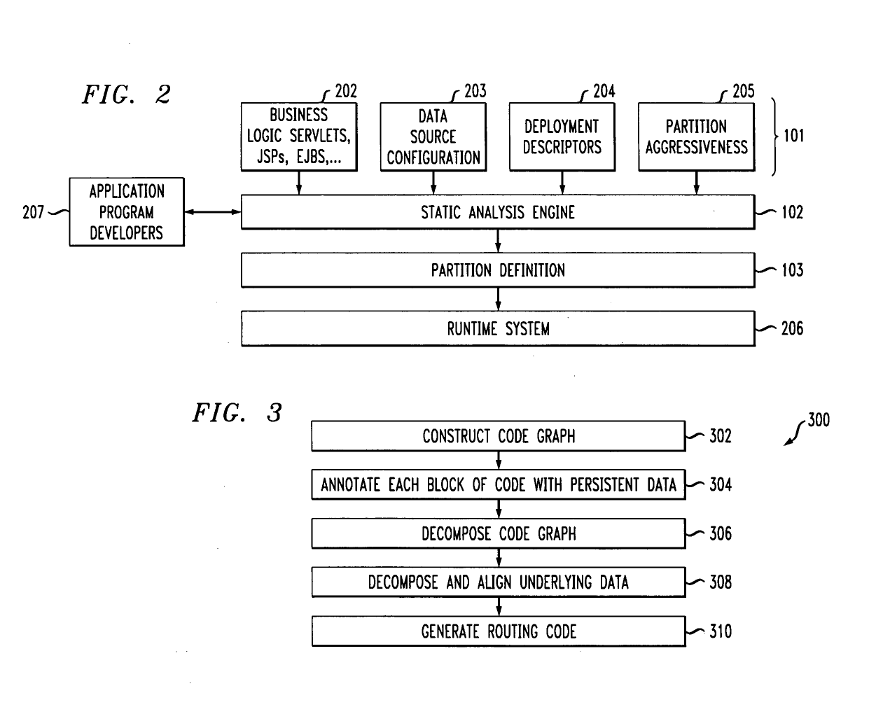

FIG. 3 illustrates a methodology for code partition of an application according to an embodiment of the invention. As shown, code partition methodology 300 comprises five steps.

The first step (step 302) is to construct the code graph of an application. A code graph describes execution flow of the application code. A code graph can be a control flow graph, where each node of the graph is a basic block. Note that when we opt to partition a control flow graph, code transformation may need to transform control transfers from one basic block to another basic block as procedure calls. A code graph can also have a coarse granularity. For example, a code graph can also be a procedure calling graph, where each node is a procedure. A code graph can also be a component calling graph, where each node is a J2EE component such as a Servlet, a Session Bean, or an Entity Bean. Static analysis engine 102 can work on either pre-deployed J2EE code or post-deployed code. The static analysis engine may employ a model of the J2EE semantics such as the mapping between remote interface and Bean interfaces of EJBs.

Further, in accordance with the methodology, the data that require consistency are determined. We call such data “persistent data.” J2EE semantics determine whether a piece of data is persistent data. For example, local variables of Servlets and stateless session beans are not persistent data since each running copy of these J2EE objects has its own copy of those local variables. On the other hand, objects of entity beans correspond to data in persistent storage and are thus considered persistent data. After these persistent data are identified, more access properties of the data can be determined. For example, the system can determine whether a piece of data is read-only through static analysis of all the application code. In some cases, the system can also estimate a relative frequency of a read operation and a write operation of each piece of data. The size of each piece of data may also be determined automatically or annotated manually.

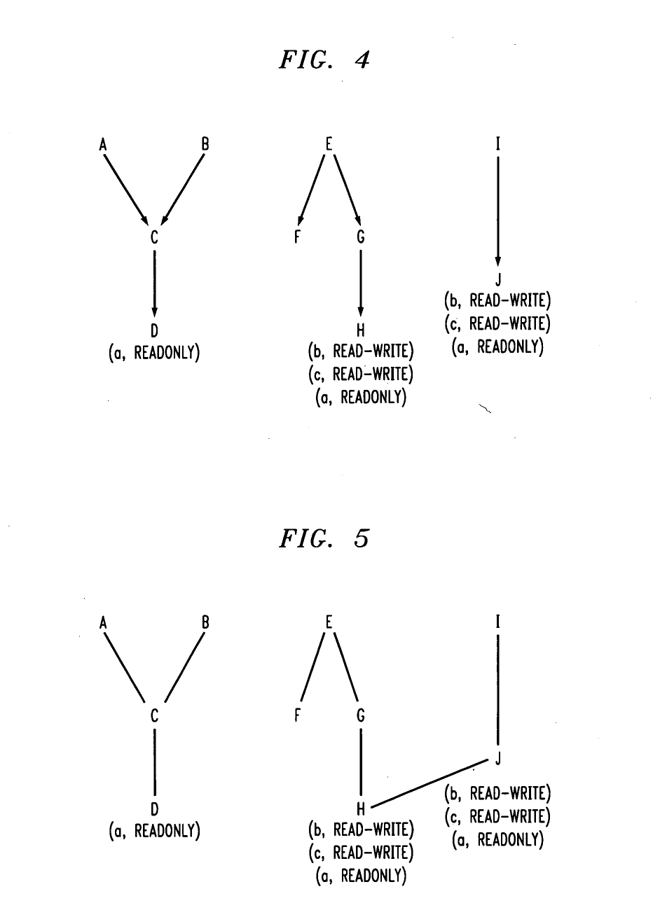

Once persistent data and access properties of these data are identified, each node in the code graph is annotated (step 304) with the underlying data and their properties. This step is further illustrated in FIG. 4. For example, the code block D is annotated with “(a, read-only),” which indicates that D accesses data “a” and data “a” is accessed only via a read operation throughout this application. The code block J is annotated with “(b, read-write) (c, read-write) (a, read-only),” which indicates that J accesses “a,” “b,” and “c,” and only data “a” are not accessed with write operations.

Then, the methodology transforms the graph by placing an edge between any two nodes that access the same piece of read-write data. This is illustrated in FIG. 5. As shown, an edge is placed between code blocks H and J. Such edges are called the read-share edges. The methodology assigns weights to these edges to indicate the consistency maintenance overhead if these data are place into two different machines. Consistency maintenance overhead includes the overhead associated with maintaining consistency for the data replicated in multiple places. For example, lock contention and transfers can increase network and processing overhead and decrease throughput. Thus, the cost includes estimated processing overhead and increasing user response time. We also assign a cost to each control transfer edge in the control flow graph. When two blocks connected by a control flow graph are partitioned, processing overhead and increasing user response time can be incurred as results of remote procedure calls. The weight of the edge indicates the cost.

Thus, the code partition problem is transformed into a graph-cut problem. Graph-cut algorithms are well known in computer science. One ordinarily skilled in such art will be able to select a graph-cut algorithm to meet the requirements of the number of required partitions. By way of example only, graph-cut techniques disclosed in J. Hao et al., “A Faster Algorithm for Finding the Minimum Cut in a Graph,” Proceedings of the 3rd ACM-SIAM Symposium on Discrete Algorithms, pp. 165-174, 1992, may be employed. The number of required partitions is influenced by the expected load of the system. It can also be influenced by the degree of success of the data partition that is described below. The graph-cut algorithm can allow iterations of code partitions and data partitions until a desired number of partitions is reached.

Step 306 represents the operation of the graph-cut algorithm, i.e., decomposition of the code graph. The graph-cut algorithm can partition data on top of a code partition. A code partition can potentially access a range of data, depending on requests. For example, a purchase servlet can process purchase requests from different customers and thus access different underlying data. A request to a code unit can be a HTTP request, a Remote Method Invocation (RMI) request, etc. It is known that an RMI request is the Java equivalent of a remote procedure call. The underlying data of a request can be determined by the parameters of the request. The parameters of the requests can be query strings for HTTP requests and arguments for an RMI call. In J2EE applications, EJB objects are usually identified by Primary Keys. Thus, the system can partition the underlying data with the parameters passed to findbyPrimaryKey calls. In some cases, to satisfy one request, one code partition may access several types of data. Thus, aligning data is essential to remove remote accesses. Alignment is performed in step 308. For J2EE applications, Container-Managed Relationship (CMR) can be used to align data accesses. Data flow analysis is usually involved.

In one embodiment, the system uses forward code slicing to extract the code that identifies primary keys and passes the code to the router to forward the requests to the correct partition. Step 310 generates the routing code. The physical location of request routers can be placed on a specialized routing node or can be in a node that also processes requests.

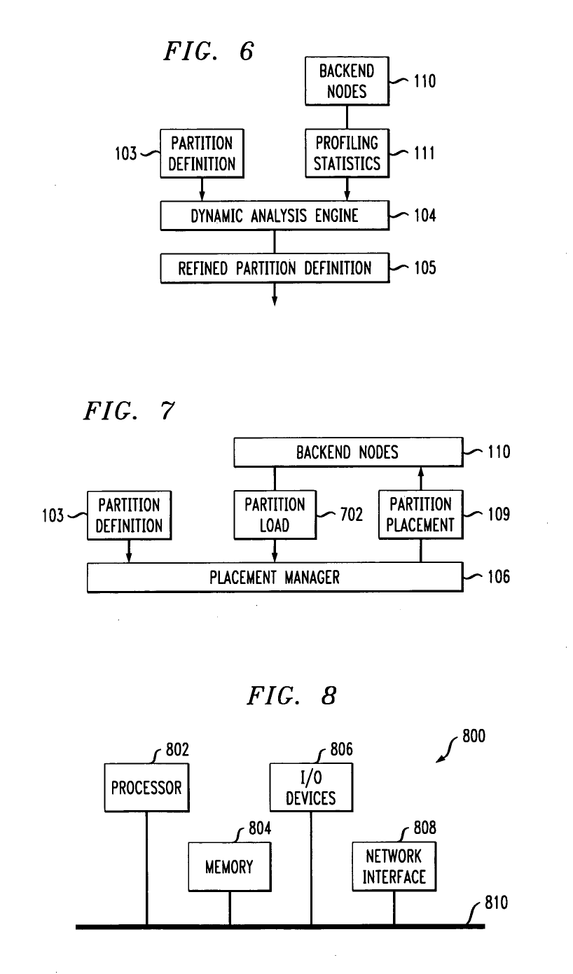

Turning now to FIG. 6, dynamic analysis engine 104 is further illustrated. As shown, input to dynamic analysis engine 104 includes the current partition definition 103 and profiling data 111 gathered at runtime by backend nodes 110. Profiling data may include the cost of remote procedure calls and data consistency conflicts among partitions. Based on the gathered statistics, dynamic analysis engine 104 can merge partitions, split partitions, or move parts of processing among partitions. The significant part of the overhead associated with dynamic analysis engine 104 is profile statistics gathering. Static analysis engine 102 can provide information to dynamic analysis engine 104 on how a performance statistic is related to another performance statistic. For example, static analysis engine 102 can determine that the number of RMI calls for Method “a” is always the same as that for Method “b.” Runtime performance statistics gathering can focus on one type of statistic and infer other types.

FIG. 7 further illustrates placement manager 106. In this example, online partition placement is depicted. Online partition placement is performed by placement manger 106. The load 702 incurred by each partition is gathered by the backend nodes 110. The load can include processing overhead, memory consumption, and disk overhead during the current period of time. The number of requests for each partition can also provide first-order estimation when the code elements of the partitions are the same. As explained above, placement manager 106 generates partition placement 109 based on partition definition 103 received from static analysis engine 102 (and/or refined partition definition 105 received from dynamic analysis engine 104) and load information 702 received from the backend nodes.

It is to be further appreciated that the present invention also comprises techniques for providing application load distribution services. By way of example, a service provider agrees (e.g., via a service level agreement or some informal agreement or arrangement) with a customer (e.g., online retailer) to host one or more services (e.g., an e-commerce web site) of the customer. Then, based on terms of the service contract between the service provider and the customer, the service provider hosts the one or more services in accordance with one or more of the application load distribution methodologies of the invention described herein.

Referring finally to FIG. 8, a computing system is illustrated in accordance with which one or more components/steps of an application load distribution system (e.g., components and methodologies described in the context of FIGS. 1 through 7) may be implemented, according to an embodiment of the present invention. It is to be understood that the individual components/steps may be implemented on one such computer system, or more preferably, on more than one such computer system. In the case of an implementation on a distributed computing system, the individual computer systems and/or devices may be connected via a suitable network, e.g., the Internet or World Wide Web. However, the system may be realized via private or local networks. The invention is not limited to any particular network.

Thus, the computing system shown in FIG. 8 represents an illustrative computing system architecture for a static analysis engine, a dynamic analysis engine, a placement manager, and/or combinations thereof, within which one or more of the steps of the techniques of the invention may be executed. The computing system shown in FIG. 8 may also represent an illustrative computing system architecture for one or more backend nodes and/or one or more request routers.

As shown, the computer system 800 may be implemented in accordance with a processor 802, a memory 804, I/O devices 806, and a network interface 808, coupled via a computer bus 810 or alternate connection arrangement.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer implemented method for distributing a load associated with an application among a plurality of computing devices, comprising of the step of:
analyzing, at a time other than runtime, code associated with the application to determine how to approximately partition the code and how to approximately partition data associated with the application to minimize a cost of interaction between partitions.

2. The method of claim 1, further comprising the step of analyzing, at runtime, the load associated with the application and partition interactions to refine one or more partition definitions.

3. The method of claim 1, further comprising the step of adjusting, at runtime, a placement of partitions based on at least one of the analysis at a time other than runtime and the analysis at runtime.

4. The method of claim 1, wherein the analysis step, at a time other than runtime, further comprises interacting with an application developer to obtain information relating to one or more execution patterns or one or more request patterns.

5. The method of claim 1, wherein the adjustment step, at runtime, is further based on a capacity associated with each of the plurality of computing devices or a request pattern of the application.

6. The method of claim 1, wherein the analysis step, at a time other than runtime, further comprises one or more of:
constructing a code graph to capture a code execution flow;
annotating code with underlying data that requires consistency;
generating a code partition that minimizes overhead and latency by reducing interactions among partitions;
partitioning the load further by partitioning underlying data and aligning partitioned data; and
generating a request-to-partition association.

7. The method of claim 6, wherein the step of annotating the code further comprises annotating the code with one or more characteristics of the data, wherein a characteristic comprises at least one of: (i) an indication that the data is read only data; (ii) an indication that the data is read and write data; and (iii) an indication of a relative read or write frequency as compared to other partitions.

8. The method of claim 1, wherein the analysis step, at a time other than runtime, inputs at least one of: (i) code associated with the application; (ii) configuration information associated with the application; (iii) one or more partition aggressiveness requirements; (iv) one or more anticipated code execution patterns; (v) one or more anticipated data access patterns; and (vi) one or more anticipated request patterns.

9. The method of claim 8, wherein the one or more partition aggressiveness requirements comprise at least one of: (i) a required number of computing devices to achieve a given throughput; (ii) a desired number of partitions; (iii) upper limits on the amount of interaction between partitions; and (iv) upper limits on the latency for each type of request resulting from control transfers between different code partitions to process the requests.

10. The method of claim 1, wherein the analysis step, at a time other than runtime, accounts for a tradeoff between efficiency and scalability by changing the number of partitions generated.

11. The method of claim 2, wherein the analysis step, at runtime, further comprises one or more of:
gathering partition interaction statistics;
gathering partition load statistics; and
refining one or more partitions based on at least one of the partition interaction statistics and the partition load statistics.

12. The method of claim 11, wherein partition refinement further comprises at least one of: (i) merging of partitions; (ii) splitting of a partition; and (iii) moving a part of a processing operation from one partition to another partition.

13. The method of claim 3, wherein partition placement adjustment, at runtime, further comprises:
inputting a measure of a processing capacity associated with each computing device;
gathering current load information for each partition; and
generating a new partition placement based on at least one of the processing capacity of each of the computing devices and the current load information for each partition.

14. The method of claim 3, wherein partition placement adjustment, at runtime, further comprises placing routing processing operations at one or more backend nodes where requests are processed.

15. A method for distributing a load associated with an application among a plurality of computing devices, comprising the step of:
analyzing a runtime request pattern to generate one or more new partition definitions or refine one or more previously-generated partition definitions.

16. The method of claim 15, wherein the analysis step, at runtime, further comprises one or more of:
gathering partition interaction statistics;
gathering partition load statistics; and
refining one or more partitions based on at least one of the partition interaction statistics and the partition load statistics.

17. The method of claim 16, wherein partition refinement further comprises at least one of: (i) merging of partitions; (ii) splitting of a partition; and (iii) moving a part of a processing operation from one partition to another partition.

18. The method of claim 17, wherein partition refinement further comprises splitting one partition based on a runtime observation that one or more code paths are rarely traversed in a code graph.

19. A method for load balancing partitions at runtime, comprising the step of:
adjusting, at runtime, a placement of partitions based on a load of at least one partition.

20. The method of claim 19, wherein partition placement adjustment, at runtime, further comprises:
inputting a measure of a processing capacity associated with each computing device;
gathering current load information for each partition; and
generating a new partition placement based on at least one of the processing capacity of each of the computing devices and the current load information for each partition.
